(19) United States
(12) Patent Application Publication
(10) Pub. No.: US 2013/0227866 A1
(43) Pub. Date: Sep. 5, 2013

(54) System for Installing and Mounting an Advertising Structure

(71) Applicant: CREASET INTERNATIONAL SARL, Clemency (LU)

(72) Inventor: Vincent Delvaux, Lasne (BE)

(73) Assignee: Creaset International SARL, Clemency (LU)

(21) Appl. No.: 13/784,256

(22) Filed: Mar. 4, 2013

(30) Foreign Application Priority Data
Mar. 5, 2012 (LU) LU91954

(51) Int. Cl. G09F 7/00

(52) U.S. Cl. CPC G09F 7/00
USPC 40/603

(57) ABSTRACT

A system for installing and mounting an advertising structure comprising a fabric (1) and supporting elements (4) for said fabric (1), the said supporting elements (4) having a lower portion and an upper portion, the said fabric (1) comprising a central print surface (2) and side edges (3), the said side edges (3) forming a peripheral frame around said central print surface (2) which is formed from a first membrane, the said side edges (3) being formed from a second membrane, the said first and second membranes being of different rigidity, the said central print surface (2) and the said peripheral frame also being secured together around their perimeter.

The present invention relates to a system for installing and mounting an advertising structure comprising a fabric and elements supporting said fabric, the said supporting elements having a lower portion and an upper portion, the said fabric comprising a central print surface and side edges, the said side edges forming a peripheral frame around said central print surface which is formed from a first membrane, the said side edges being formed from a second membrane, the said first and second membranes being of different rigidity, the said central print surface and the said peripheral frame also being secured to each other around their perimeter.

Said system for installing and mounting an advertising structure is known and generally comprises a metal frame as supporting element fixed to a surface e.g. a wall, or which has feet. A fabric provided with eyelets on its periphery is placed in the centre of the said metal frame, the said fabric being attached to the said metal frame via a cable or elastic which is passed through the said eyelets of the said fabric before being secured to the said metal frame.

For example, document US2006/0174525 describes fabric display panels of which part can be formed in a stretchable material, the said display panels comprising a series of apertures intended to receive connecting means allowing said display panels to be fixed to a supporting frame. These fixing means may be fasteners present on the said supporting frame for example, or Velcro, hooks provided on the said display panels, or rods inserted in a hem formed on the perimeter of the said display panels, these rods at their ends being provided with hooks or rings intended to be fixed onto the said supporting frame. Document US2006/0174525 therefore discloses display panels which necessarily require supporting frames formed of numerous elements on which the display panels are attached via fastening means.

Unfortunately, said system based on the use of a metal frame as supporting element in the centre of which a fabric is held in position via fastening elements attaching it to the said supporting frame, is restrictive since on account of the weight of the metal structure and its numerous constituent components, several persons are required for the assembling thereof which generally takes several hours. In addition, said system is not easily removable since the entire metal structure supporting the fabric must be dismounted. In addition, the use of means to attach the said fabric to the said supporting frame makes the placing in position of the advertising structure much more complex and therefore considerably increases the time needed to install this advertising structure.

It is the objective of the invention to overcome the above-mentioned disadvantages by providing a lightweight system comprising few elements for installing and mounting an advertising structure, this system allowing rapid mounting and dismounting of the advertising structure, these operations able to be performed by a single person.

Therefore, to solve these problems, the invention provides for a system to install and mount an advertising structure such as first indicated above, characterized in that the rigidity of the said second membrane forming the said peripheral frame allows the tensioning of the entire said fabric when the said peripheral frame is stretched to encompass said upper portion of the said supporting elements supporting the said fabric.

Said advertising structure makes it possible to avoid the use of heavy metal structures having numerous elements since, according to the present invention, the said second membrane allows easy, rapid setting-up of the said advertising structure because the said second membrane forming the said peripheral frame allows the tensioning of the entire said fabric by encompassing only a few lightweight supporting elements. This is of particular advantage since it is no longer necessary to use either a heavy metal frame that is not easily removable and is restrictive, or to use fastening means to fasten the said fabric to the said supporting frame when mounting an advertising structure.

Advantageously, the said first and second membranes are formed from polymers. This allows a lightweight, flexible fabric to be obtained.

According to one embodiment of the system for installing and mounting an advertising structure according to the invention, the said print surface and the said side edges are formed from membranes derived from one same polymer, the said membranes having different rigidities. Advantageously, the rigidity of the said first membrane forming the said central print surface must be sufficient so that the said central print surface is able to be tensioned wrinkle-free. On the other hand, the rigidity of the said second membrane forming the said peripheral frame must allow the stretching of the said peripheral frame so that it is able to encompass said supporting elements and thereby allow the tensioning of the said fabric assembly, the said first and second membranes being secured together.

According to one alternative embodiment of the system for installing and mounting an advertising structure according to the invention, the said print surface and said side edges are respectively formed from a first and a second membrane derived from different polymers, said first and second membranes being of different rigidity. Advantageously, this embodiment allows the use of membranes derived from different polymers whilst acting on the rigidities of each of the said first and second membranes.

Evidently, according to the above-indicated embodiments, the thickness of the polymers may be the same or different.

Preferably, the said supporting elements are placed at regular intervals along axes defined by the said side edges, which must be stretched to encompass the upper portion of the said supporting elements such that the said fabric is tensioned over its entire surface. The arrangement of the supporting elements is to be determined by those skilled in the art depending on the size of the said fabric and in accordance with the respective characteristics of the said print surface and said side edges, the objective being—after the said side edges forming the said peripheral frame have been stretched—to obtain tensioning of the entire said fabric.

Advantageously, the said supporting elements are masts, poles or posts positioned along axes defined by said side edges forming a peripheral frame around the said central print surface. Compared with the supporting elements described in the prior art, the supporting elements according to the present invention have the advantage of being independent of each other thereby facilitating the installing thereof, which is all the quicker if holes are previously made in the ground to receive these elements. Evidently, these holes are provided beforehand and all that is required is to insert the supporting elements therein when installing and mounting an advertising structure of the invention.

Preferably, the said supporting elements are of different heights. This is of particular advantage if the advertising structure of the invention needs to be tilted, and by acting on the height of the supporting elements it is possible to define the desired tilt angle of the said advertising structure. It is also possible, depending on the heights of each of the supporting elements and on their relative positioning, to define height differences between the different areas of the said print surface.

Preferably, the said central print surface is formed of an assembly of membranes, the said membranes being assembled together by high frequency welding.

Assembly using high frequency welding, or any other suitable type of welding, allows several fabrics of large size to be juxtaposed thereby allowing large-size advertising structures to be obtained.

Preferably, said central print surface and said peripheral frame are joined by high frequency welding or via a bayonet or an eyelet system in which a cable is passed. High frequency welding, or any type of suitable welding, ensures permanent assembling of the print surface and side edges forming said peripheral frame, whilst advantageously the said bayonet or eyelet systems through which a cable is passed allow the said print surface and said peripheral frame to be separated whenever desired. It is thus possible to re-use the said peripheral frame which can subsequently be secured to another print surface.

Advantageously, the advertising structure according to the invention further comprises at least one safety device having a first end and a second end, the said first end of the said safety device being fixed to at least one of said side edges, the said second end of said safety device being fixed to an anchor point positioned underneath the horizontal plane formed by the surface of said tensioned fabric. Said safety device allows the advertising structure assembly to be made secure essentially when it is set up outdoors for example at a football stadium to prevent the said fabric from becoming separated from the supporting elements and thereby causing a safety hazard which could be the case for example in the event of gusts of wind.

Preferably, the said first end of said safety device is fixed to a side edge by high frequency welding or using any adequate fastening means, for example a bayonet or an eyelet system through which a cable is passed.

Preferably, the said second end of said safety device is fixed to the ground using any suitable fixing means e.g. a peg.

Other embodiments of the device according to the invention are indicated in the appended claims.

The present invention also pertains to an advertising structure according to the invention for setting up advertisements on planar or angled surfaces or surfaces of different levels. The use of an advertising structure according to the invention is therefore adapted to any type of surface e.g. a lawn, a roof, or a supporting medium of varying height such as football stadium stands whose rows of seating are at different levels.

Other forms of use of the device according to the invention are indicated in the appended claims.

Other characteristics, details and advantages of the invention will become apparent from the description given below as a non-limiting illustration and with reference to the appended drawings.

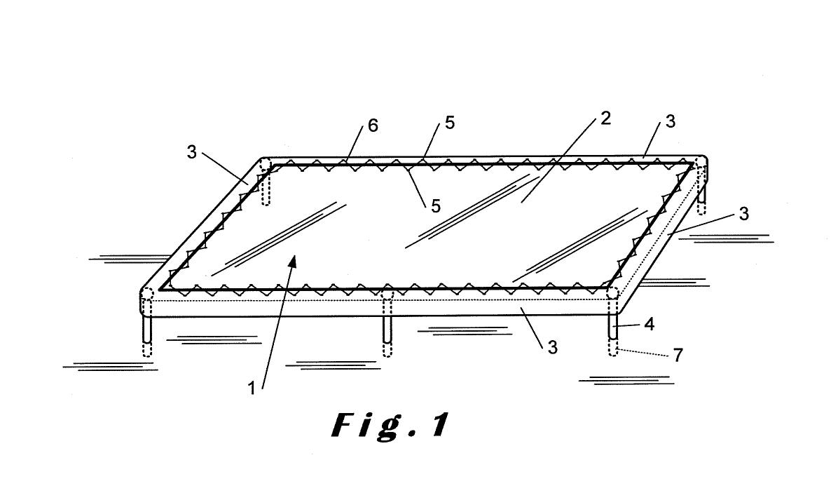

FIG. 1 illustrates one embodiment of the system for installing and mounting an advertising structure according to the invention.

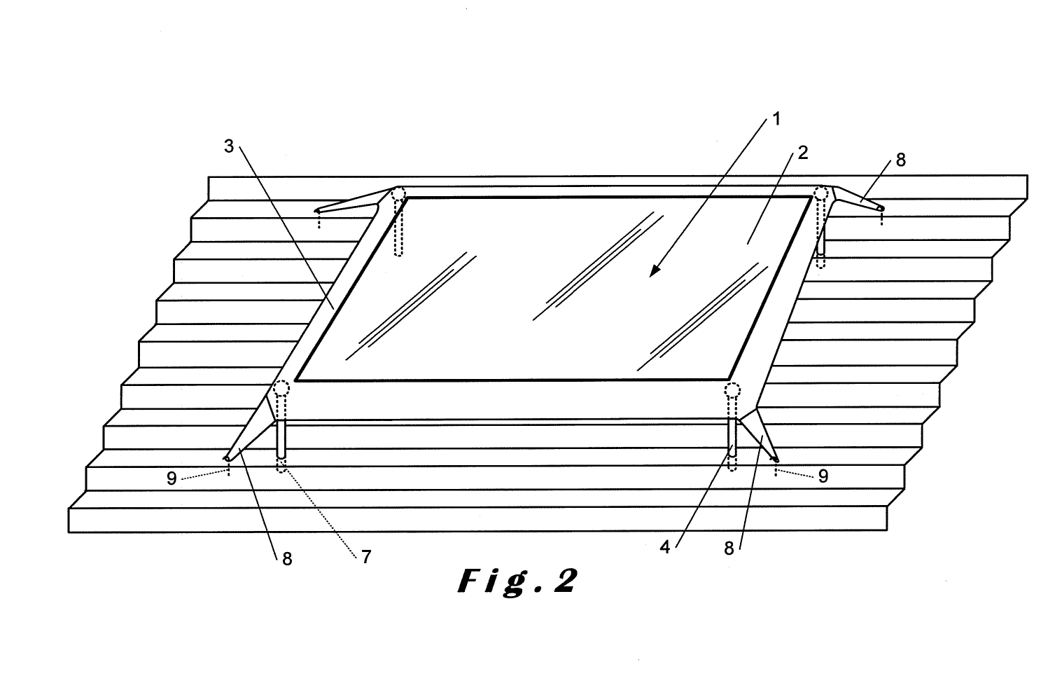

FIG. 2 illustrates another embodiment of the system for installing and mounting an advertising structure according to the invention.

In the Figures, same or similar elements carry the same references. FIG. 1 illustrates the system for installing and mounting an advertising structure of the invention according to one particular embodiment. The fabric (1) comprises a central print surface (2) provided with eyelets (5) on its perimeter and with side edges (3) forming a peripheral frame around the said central print surface (2), the said peripheral frame also being provided with eyelets on its perimeter in contact with the said central print surface (2). The central print surface (2) is secured to the side edges (3) forming the peripheral frame via an eyelet system (5) comprising a cable (6) alternately passing through the eyelets (5) of said central print surface (2) and those of said peripheral frame. Supporting elements (4) in the form of posts are arranged along the axes defined by the said side edges (3) being inserted in holes (7) made in the ground for this purpose. These supporting elements (4) are placed in such manner that the said side edges (3) must be stretched to encompass the upper portion of the said supporting elements (4), which allows the entire said fabric (1) to be tensioned since the side edges (3) are secured to the said central print surface (2).

FIG. 2 illustrates the system for installing and mounting an advertising structure of the invention according to another particular embodiment. According to this embodiment, the advertising structure is placed on a support having different levels (stepped support) and comprises the same elements as those described in FIG. 1 with the difference that the said central print surface (2) is secured to the side edges (3) forming a peripheral frame by high frequency welding. In addition, safety devices (8) are added at the four corners of the said fabric (1). These safety devices (8) are fixed via one of their ends to the side edges (3) of the said fabric (1) by high frequency welding, the other end of the said safety devices (8) being fixed to the ground via a peg (9).

The present invention is evidently in no way limited to the above-described embodiments and numerous modifications can be made thereto without departing from the scope of the appended claims.

1. A system for installing and mounting an advertising structure comprising a fabric (1) and supporting elements (4) for said fabric (1), the said supporting elements (4) having a lower portion and an upper portion, the said fabric (1) comprising a central print surface (2) and side edges (3), the said side edges (3) forming a peripheral frame around the said central print surface (2) which is formed from a first membrane, the said side edges (3) being formed from a second membrane, the said first and second membranes being of different rigidity, the said central print surface (2) and the said peripheral frame also being secured together around their perimeter, characterized in that the said second membrane forming the said peripheral frame is of rigidity allowing the tensioning of the entire said fabric when the said peripheral frame is stretched to encompass the said upper portion of the said supporting elements (4) of the said fabric (1).

2. The system for installing and mounting advertising structure according to claim 1, characterized in that the said first and second membranes are formed from polymers.

3. The system for installing and mounting an advertising structure according to claim 2, characterized in that the said print surface (2) and the said side edges (3) are formed from membranes derived from one same polymer, the said membranes being of different rigidity.

4. The system for installing and mounting an advertising structure according to claim 2, characterized in that the said print surface (2) and the said side edges (3) are formed from membranes derived from different polymers, the said membranes being of different rigidity.

5. The system for installing and mounting an advertising structure according to claim 1, characterized in that the said supporting elements (4) are positioned at regular intervals along the axes defined by the said side edges (3) which must be stretched to encompass the upper portion of the said supporting elements (4) such that the said fabric (1) is tensioned over its entire surface.

6. The system for installing and mounting an advertising structure according to claim 1, characterized in that the said supporting elements (4) comprise: masts, poles or posts.

7. The system for installing and mounting advertising structure according to any claim 1 characterized in that the said supporting elements (4) are of different height.

8. The system for installing and mounting an advertising structure according to claim 1, characterized in that the said central print surface (2) is formed of an assembly of membranes, the said membranes being assembled together by high frequency welding.

9. The system for installing and mounting an advertising structure according to claim 1, characterized in that the said central print surface and the said peripheral frame are secured by high frequency welding.

10. The system for installing and mounting an advertising structure according to claim 1, characterized in that the said central print surface and the said peripheral frame are secured via a bayonet system through which a cable (6) is passed.

11. The system for installing and mounting an advertising structure according to claim 1, characterized in that the said central print surface and the said peripheral frame are secured via an eyelet system (5) through which a cable (6) is passed.

12. The system for installing and mounting an advertising structure according to claim 1, characterized in that it further comprises at least one safety device (8) having a first end and a second end, the said first end of the said safety device (8) being fixed to at least one of the said side edges (3), the said second end of the said safety device (8) being fixed to an anchor point positioned underneath the horizontal plane formed by the surface of the said fabric (1) when tensioned.

13. An advertising structure according to claim 1 for installing advertisements on planar or angled surfaces, or surfaces having different levels.
